(19) United States
(12) Patent Application Publication
(10) Pub. No.: US 2016/0040522 A1
(43) Pub. Date: Feb. 11, 2016

(54) PRODUCTION OF INJECTION WATER BY COUPLING DIRECT-OSMOSIS METHODS WITH OTHER METHODS OF FILTRATION

(71) Applicant: TOTAL SA, Courbevoie (FR)

(72) Inventors: Matthieu Jacob, Cescau (FR); Nicolas Lesage, Billere (FR); Pierre Pedenaud, Lescar (FR); Philippe Coffin, Lescar (FR)

(21) Appl. No.: 14/781,849

(22) PCT Filed: Apr. 1, 2014
(86) PCT No.: PCT/FR2014/050777

§ 371 Date: Oct. 1, 2015

(30) Foreign Application Priority Data
Apr. 3, 2013 (FR) 13 52988

(51) Int. Cl. E21B 43/40; C02F 1/44; B01D 61/58; B01D 61/00; B01D 61/02

(52) U.S. Cl. CPC E21B 43/40; B01D 61/002; B01D 61/025; B01D 61/027; B01D 61/58; C02F 1/44; C02F 1/441; C02F 1/442; C02F 2103/10

(57) ABSTRACT

The invention relates to a method for extracting hydrocarbons. The steps involve extracting a process flow from an underground formation, separating this flow into at least one hydrocarbon-containing fraction and one aqueous fraction referred to as the produced water, and reinjcting an injection water into the underground formation. The injection water intended to be introduced into the underground formation is produced partly in a direct-osmosis unit from produced water and partly in a nanofiltration and/or reverse-osmosis unit. The invention also relates to a process for extracting hydrocarbons throughout the exploitation life of the underground hydrocarbon reservoir, and to an injection-water production device especially designed for implementing this process.

### RELATED APPLICATIONS

The present application is a National Phase entry of PCT Application No. PCT/FR2014/050777, filed Apr. 1, 2014, which claims priority from FR Patent Application No. 13 52988, filed Apr. 3, 2013, said applications being hereby incorporated by reference herein in their entirety.

### TECHNICAL FIELD OF THE INVENTION

The present invention falls within the general context of the management of water in hydrocarbon extraction. More specifically, the present invention relates to a process for extracting hydrocarbons, wherein the injection water intended to be introduced into the underground formation is produced partly in a direct-osmosis unit from produced water and partly in a nanofiltration and/or reverse-osmosis unit. This process may be included in a more general process for extracting hydrocarbons throughout the exploitation life of the underground hydrocarbon reservoir. The present invention also relates to an injection-water production device especially designed for implementing the above process.

### BACKGROUND OF THE INVENTION

During the production of hydrocarbons, the flow extracted from the underground formation is typically a mixture of hydrocarbons, water and solid particles. This flow, called production flow, is generally treated by settling out and/or by hydrocycloning and/or by means of a floatation unit so as to separate it into at least one exploitable hydrocarbon-containing fraction and one aqueous fraction called produced water.

Produced water is a by-product of hydrocarbon extraction, the management of which can be problematic. This is because the produced water essentially contains water, but also numerous compounds which cannot be discharged without prior treatments. Processes exist in the literature which make it possible to treat produced water before it is discharged into the environment, for example by concentrating the polluting compounds of the produced water and separating them from the pure water by direct osmosis, as described in patent application US 2009/261040. In these processes, a hypertonic synthetic solution is generally used as osmotic vector. Water that can be discharged into the environment is thus obtained.

An alternative consists in reinjecting the produced water into the hydrocarbon reservoir. Indeed, throughout oil production, the pressure in the reservoir decreases owing to the extraction of the hydrocarbons. In order to maintain the reservoir at pressure, it is known practice to inject into said reservoir a fluid, generally water, of sufficient quality for it not to cause any modification of the underground formation. The particle concentration, the size of these particles, the turbidity, the saline concentration, the oxygen concentration and the hydrocarbon concentration of the injected fluid must in particular be controlled such that they do not exceed certain values.

The volume of produced water available may not be sufficient to cover the reinjection fluid needs. A provision of water suitable for injection is then required.

The origin of the injection water generally depends on availability and on constraints around the site of the hydrocarbon extraction. For example, in the case of offshore extraction, it is known practice to use water taken from the sea. Treatment steps are, however, generally essential in order to obtain, from the seawater, a water of which the quality is sufficient to be able to be reintroduced into the underground formation. These treatments consist in particular of removal of the particles and of the microorganisms, of desulfation and of deoxygenation.

The injection water may also be aquifer water, river water or lake water, and optionally domestic or industrial wastewater. Here also, treatment steps may be required in order to obtain water of which the quality is compatible with injection into the underground formation.

When the injection water is seawater, the presence of sulfate in the water is typically problematic if the underground formation contains barium ions. This is because barium and sulfate ions form precipitates which create mineral deposits (scaling) that are prejudicial to good hydrocarbon extraction. In addition, the presence of sulfates may be responsible for the generation, by sulfate-reducing bacteria, of hydrogen sulfide (H₂S), a toxic and corrosive gas, which can cause corrosion of the pipes used to recover the hydrocarbons. Removal of the sulfates from the water before it is injected into the underground formation is therefore sometimes required.

A conventional process which makes it possible to remove the sulfates from water consists of a membrane nanofiltration process, which retains the multivalent ions and allows the monovalent ions to pass through. Another conventional process which allows desalting of water consists of a reverse-osmosis process. Such processes are, for example, described in patent applications WO 2006/134367 and WO 2007/138327.

The nanofiltration and reverse-osmosis processes have the major drawback of consuming energy to create a pressure gradient required for the water to pass through the membrane.

Processes using direct osmosis have also been described.

Patent application US 2007/0246426 proposes a process for recovering hydrocarbons, which comprises obtaining low-salinity injection water by direct osmosis. In this process, high-salinity water, in particular seawater, is brought into contact, via an osmosis membrane, with an aqueous solution comprising an extractable solute, having a greater osmolality than water. Said solute is then removed by various methods, for example by precipitation or by vaporization. Such a process therefore requires the implementation of additional treatment steps, which are not conventional on a hydrocarbon extraction site. In addition, these additional steps also consume energy.

A similar process has been described in international patent application WO 2005/012185. Said document describes a process for separating the solvent from a first solution, in particular of seawater, by direct osmosis against a second solution which has a higher osmotic potential than the first solution. This second solution may in particular be a synthetic solution. The solvent is then extracted from this second solution by various conventional techniques such as ion exchange, electrodialysis, nanofiltration, reverse osmosis, multi-stage or multiple-effect flash distillation, mechanical vapor compression, rapid spray desalination and crystallization. This process therefore requires the implementation of at least two consecutive treatment steps, with increased energy consumption, and the use of a synthetic solution, the management of which, in a natural environment, may be problematic.

International patent application WO 2010/067063 is presented as an improvement of the process described in WO 2005/012185. In order to improve the stability of the process over time, the step of extracting the solvent in the second solution is carried out either by reverse osmosis, or a thermal method. Furthermore, intermittently, a part of the concentrated solution recovered after extraction of the solvent is passed over a nanofiltration membrane for additional separation of the solvent. This process therefore comprises three different treatment steps, thereby making the process described in WO 2005/012185 even more complex.

Moreover, international patent application WO 2006/120399 describes a process for injecting water into an underground formation, wherein the injection water consists only of produced water having a strong solute concentration, diluted by direct osmosis with an aqueous solution having a lower solute concentration. This aqueous solution may be seawater. Patent application FR 11 58956, filed by the applicant company, also describes such a process which can be particularly advantageous when the hydrocarbon extraction is an offshore extraction.

However, during its research studies, the applicant company has discovered that the processes described in WO 2006/120399 and in FR 11 58956 are not always applicable.

Indeed, it is known that the need for injection water varies over time, throughout the exploitation of an underground hydrocarbon reservoir. Likewise, the amount of produced water produced varies according to the stage of exploitation of the reservoir. This is, for example, mentioned in international patent application WO 2012/049619.

As it happens, a simulation has demonstrated that, taking into account the performance levels of the current direct-osmosis membranes, it is not possible, during the first years of exploitation of the hydrocarbon reservoir, to produce a sufficient amount of injection water solely by the direct-osmosis process described in WO 2006/120399 and in FR 11 58956. The need which consists in having available a process for producing injection water at low energy cost, which does not have the drawbacks of the prior art, is therefore still not completely met.

Furthermore, using various processes for producing injection water consecutively, according to the stage of exploitation of the underground formation, can have drawbacks. Each process requires different equipment which can be expensive and require space that is sometimes not available. Using various processes for producing injection water can therefore represent an increased cost and an undesired increase in complexity of the process for exploiting the underground reservoir.

### SUMMARY OF THE INVENTION

One of the objectives of the present invention is to provide a process for extracting hydrocarbons wherein the injection water required for the extraction of the hydrocarbons is produced in a sufficient amount, at a minimal energy cost, throughout the exploitation of the underground hydrocarbon reservoir.

The invention also aims to achieve at least one of the following objectives:
to provide a process for extracting hydrocarbons wherein injection water, the quality of which is sufficient to be introduced into the underground formation, is obtained from readily available water, even if said water comprises an undesirable solute, such as sulfate;
to provide a process for extracting hydrocarbons wherein the produced water is made use of;
to provide a process for extracting hydrocarbons that is suitable for all the stages of exploitation of the hydrocarbon reservoir;
to propose a process for extracting hydrocarbons that is simple to carry out throughout the exploitation of the hydrocarbon reservoir;
to provide a process for extracting hydrocarbons which requires a device for producing injection water that does not take up much space and that is inexpensive.

In addition, it is desired to provide an injection-water production device which can be used optimally throughout the exploitation of the hydrocarbon reservoir.

A subject of the present invention is a process for extracting hydrocarbons comprising the steps of:
extracting a production flow from an underground formation;
separating this flow into at least one hydrocarbon-containing fraction and one aqueous fraction referred to as the produced water, and
reintroducing an injection water into the underground formation,
   wherein:
at least a first part of said injection water is a permeate obtained by bringing into contact, via a direct-osmosis membrane, at least one part of the produced water and water having an osmotic pressure lower than the pressure of the produced water and comprising an undesirable solute, and
at least a second part of said injection water is a permeate obtained by nanofiltration and/or reverse osmosis of water comprising an undesirable solute.

According to one preferred embodiment, said water having an osmotic pressure lower than the osmotic pressure of the produced water and said water comprising an undesirable solute are seawater. Furthermore, the undesirable solute may be the sulfate ion.

In addition, said second part of injection water which is a permeate obtained by nanofiltration and/or reverse osmosis may preferably be a permeate obtained by improved nanofiltration and/or improved reverse osmosis of water comprising an undesirable solute, the water comprising an undesirable solute being brought into contact, via respectively a nanofiltration and/or reverse-osmosis membrane, with produced water.

In addition, a subject of the present invention is a process for extracting hydrocarbons with injection water, wherein,
during a first exploitation stage, the injection water is a permeate obtained by nanofiltration and/or reverse osmosis of water comprising an undesirable solute;
during a second exploitation stage, at least one part of the injection water is a permeate obtained by nanofiltration and/or reverse osmosis of water comprising an undesirable solute, and at least one other part of the injection water is a permeate obtained by bringing into contact, in a direct-osmosis unit, on both sides of an osmosis membrane, at least one part of produced water and water having an osmotic pressure lower than the pressure of the produced water and comprising an undesirable solute; and
during a third exploitation stage, the injection water is a permeate obtained by bringing into contact, in a direct-osmosis unit, on both sides of an osmosis membrane, produced water and water having an osmotic pressure lower than the pressure of the produced water and comprising an undesirable solute.

Finally, a subject of the invention is also an injection-water production device especially designed for implementing the above process. This device comprises several filtration units, each unit comprising at least one filtration membrane chosen from membranes of nanofiltration type, of reverse-osmosis type and of direct-osmosis type, the filtration membrane of each unit being removable and can be replaced with a filtration membrane of another type.

### BRIEF DESCRIPTION OF THE FIGURE

FIG. 1 represents diagrammatically an embodiment of the process according to the invention.

### DETAILED DESCRIPTION OF THE FIGURE

A subject of the present invention is therefore a process for extracting hydrocarbons. Said process comprises at least the steps of:
extracting a production flow from an underground formation;

separating this flow into at least one hydrocarbon-containing fraction and one aqueous fraction referred to as the produced water;
reintroducing an injection water into the underground formation.

In the present invention, the term “production flow” refers to the flow derived from an underground formation containing hydrocarbons. The production flow is a mixture of hydrocarbons, water and, possibly, of solid particles and gas. This production flow is separated into several fractions in a separation unit, such as a two- or three-phase primary separator. At least one hydrocarbon-containing fraction is recovered in a hydrocarbon collection line and one aqueous fraction is drawn off Said fraction is then treated in various devices such as settling devices, hydrocyclones, floatation units, membrane filtration units or any other appropriate treatment unit intended to separate the particles and the dispersed hydrocarbons from the aqueous fraction.

In the present invention, the term “produced water” refers to the aqueous fraction obtained after separation of the production flow.

The produced water can contain impurities, for example:
suspended particles, the diameter of which can range from a few nanometers to a few micrometers according to the treatments used,
microorganisms,
dissolved salts,
heavy metals,
dissolved organic compounds, in particular hydrocarbons,
insoluble organic compounds in dispersion, in particular hydrocarbons,
dissolved gases.

The concentration of dispersed hydrocarbons and of suspended particles in the produced water is typically between 0 and 500 mg/l.

The produced water has a given osmotic pressure denoted Π_{P}. In the present invention, the term “osmotic pressure” of a solution denotes the pressure that must be exerted on the solution in order to prevent the solvent from crossing a semipermeable osmosis membrane, said solution being on one side of the membrane and its solvent in the pure state being on the other side. The osmotic pressure Π_{P} of the produced water may be between 0 and 200 bar. This osmotic pressure is generally essentially due to the presence of chloride, sodium, potassium, sulfate, magnesium, calcium, strontium and/or barium ions in the produced water.

In the present invention, the term “injection water” is intended to mean water of which the physicochemical characteristics make it suitable for being injected into the underground formation. These physicochemical characteristics depend essentially on the nature of the underground formation into which the reinjection is carried out. They can be determined by those skilled in the art. By way of example, in order to be able to be used as injection water, the water can have a concentration of dispersed hydrocarbons of between 0 and 500 mg/l, a particle concentration of between 0 and 200 mg/l, and a particle size of between 0.5 and 20 micrometers.

In addition, the injection water can have a sulfate concentration advantageously less than 50 mg/l, more preferably less than 40 mg/l and even more preferably less than 10 mg/l. If it observes these physicochemical characteristics, the produced water can itself be used directly as injection water.

In the process which is the subject of the present invention, the injection water introduced into the underground formation consists of at least two distinct flows, which have been obtained simultaneously by two different techniques:
at least a first part of said injection water is obtained by direct osmosis,
at least a second part of said injection water is obtained by nanofiltration and/or reverse osmosis.

Direct osmosis is a well-known physicochemical phenomenon which consists of the diffusion of the solvent from a solution of low osmotic pressure to a solution of high osmotic pressure through an osmosis membrane.

In the process which is the subject of the present invention, in order to obtain the first part of the injection water, at least one part of the produced water is brought into contact, via a direct-osmosis membrane, with water of which the osmotic pressure is lower than the osmotic pressure of the produced water and which comprises at least one undesirable solute.

For this, at least one part of the produced water can be introduced into a filtration unit comprising a direct-osmosis membrane, on a first side of said membrane. The produced water can have a sulfate concentration advantageously less than 1000 mg/l, more preferably less than 200 mg/l, and even more preferably less than 100 mg/l. Introduced on a second side of said membrane is water having an osmotic pressure Π_{M} lower than the osmotic pressure of the produced water Πₚ and comprising at least one undesirable solute, which makes said water unfit to be injected as it is into the underground formation. The undesirable compounds typically lead to risks of precipitation, corrosion, and bacterial proliferation. Generally, they can damage oil plants and are harmful to the underground formation.

Said water having an osmotic pressure Π_{M} below the osmotic pressure of the produced water Π_{P} can be chosen from the group consisting of seawater, lake water, river water, aquifer water, domestic wastewater and industrial wastewater.

Preferably, said water is seawater. The selection of seawater is particularly advantageous if the hydrocarbon extraction is offshore. Seawater at 25° C. has an osmotic pressure of approximately 25 bar. In one embodiment where the water having an osmotic pressure lower than the osmotic pressure of the produced water is seawater, the produced water preferably has an osmotic pressure greater than 25 bar, more preferentially greater than 35 bar, even more preferentially greater than 45 bar, and in particular of between 75 bar and 200 bar. The undesirable solute is typically the sulfate ion, the concentration of which in seawater is typically between 1 and 10 g/l.

In one embodiment where the water having an osmotic pressure lower than the osmotic pressure of the produced water is water originating from an aquifer, the undesirable solute is any type of ion that can precipitate with a counterion of the produced water, and also any organic molecule that can cause a significant environmental impact in the event of injection into the underground formation.

The difference in osmotic pressure between the solutions on either side of the membrane is responsible for the diffusion phenomenon. The water having the lowest osmotic pressure diffuses through the membrane. The diffusion flow can be typically calculated according to the following formula:

Q_{DO}=S_{DO}×L_{P(DO)}×K_{(DO)}×(Π_{P(DO)}−Π_{M})

wherein

Q_{DO} denotes the flow rate of diffusion by direct osmosis (in l·h⁻¹),

S_{DO} denotes the surface area of the direct-osmosis membrane (in m²),

L_{P(DO)} denotes the permeability of the osmosis membrane (in 1·h⁻¹·m⁻²·bar⁻¹),

K_{(DO)} denotes the apparent osmotic pressure coefficient, which depends in particular on the operating conditions and type of osmosis membrane, and

Π_{P(DO)} and Π_{M} denote the osmotic pressure of, respectively, the produced water and the water having an osmotic pressure lower than the osmotic pressure of the produced water (in bar).

The difference in osmotic pressure (Π_{P(DO)}−Π_{M}) can preferably be greater than 10 bar, more preferably greater than 20 bar, and even more preferably between 50 bar and 200 bar.

At the outlet of the filtration unit comprising a direct-osmosis membrane, two flows are obtained:
a concentrate originating from the compartment into which the water having an osmotic pressure lower than the osmotic pressure of the produced water enters. Its physicochemical characteristics correspond to those of the flow entering this compartment of the unit, except for a concentration factor. Typically, the concentration of the undesirable solute is higher in the concentrate than in the water having an osmotic pressure lower than the osmotic pressure of the produced water. On the other hand, its flow rate is lower. The concentrate can be expelled from the filtration unit and discharged into the environment in an appropriate manner according to the regulations in force;
a permeate originating from the compartment into which the produced water enters. Its physicochemical characteristics correspond to those of the produced water except for a dilution factor. The permeate is advantageously used in the process for extracting hydrocarbons as a part of the injection water.

By virtue of this direct-osmosis technique, the first part of the injection water that is of use to the process for extracting hydrocarbons is obtained from produced water and from water having an osmotic pressure lower than the osmotic pressure of the produced water, with a minimum energy input. The water having an osmotic pressure lower than the osmotic pressure of the produced water can be chosen from readily available waters, even if said waters comprise an undesirable solute, such as sulfate. In addition, advantage is taken, in the process according to the invention, of the produced water that was in the prior art often considered to be a by-product.

However, the volume of injection water thus produced is limited by the volume of produced water that is available. As it happens, in particular at the initial stage of the extraction of hydrocarbons from an underground formation, the volume of produced water is low. Consequently, the production of injection water by direct osmosis can be combined with a production of injection water by one or more other methods.

In the process according to the invention, at least a second part of said injection water is a permeate obtained by nanofiltration and/or reverse osmosis of water comprising an undesirable solute.

The nanofiltration technique is a well-known specific filtration technique in which a solvent is forced to pass through a nanofiltration membrane by applying a sufficient pressure thereto. Because of the pore size of the membrane, all the solutes are retained, with the exception of the monovalent ions. Reverse osmosis is, for its part, based on the same physicochemical phenomenon as direct osmosis, except for the difference that, since the solution is subjected to an external pressure greater than its osmotic pressure, the diffusion of the solvent through an osmosis membrane is reversed: the diffusion takes place from a solution of high osmotic pressure to a solution of low osmotic pressure.

The water comprising an undesirable solute can be chosen from the group consisting of seawater, lake water, river water, aquifer water, domestic wastewater and industrial wastewater. When it is seawater, the undesirable solute is typically the sulfate ion, the concentration of which in seawater is typically between 1 and 10 g/l. When it is water originating from an aquifer, the undesirable solute is any type of ion that can precipitate with a counterion of the produced water, and also any organic molecule that cause a significant environmental impact in the event of injection. Preferably, said water comprising an undesirable solute used in this nanofiltration and/or reverse-osmosis step is the same as the water having an osmotic pressure lower than the osmotic pressure of the produced water used in the direct osmosis step described above. Preferably, said water is seawater, in particular if the hydrocarbon extraction is offshore.

At least one part of the water comprising an undesirable solute is introduced into a filtration unit comprising a nanofiltration membrane or a direct-osmosis membrane, on a first side of said membrane. A sufficient pressure is applied to said water comprising an undesirable solute in such a way that the water passes through the membrane.

According to one particularly advantageous embodiment, the nanofiltration and/or reverse-osmosis technique used may be an improved nanofiltration and/or an improved reverse osmosis. The term “improved nanofiltration” and “improved reverse osmosis” is intended to mean herein a filtration process, respectively nanofiltration and reverse-osmosis process, wherein said water comprising an undesirable solute is brought into contact, via a corresponding filtration membrane, with produced water. Thus, according to this embodiment, said second part of the injection water is a permeate obtained by improved nanofiltration and/or by improved reverse osmosis of water comprising an undesirable solute, the water comprising an undesirable solute being brought into contact, via respectively a nanofiltration and/or reverse-osmosis membrane, with produced water.

Contrary to the conventional nanofiltration or reverse-osmosis process, wherein the filtration unit has only a single inlet (the feed) and two outlets (the permeate and the concentrate), the “improved” filtration process is carried out with a unit which has two inlets: in addition to the normal feed, produced water is introduced on the permeate side of the corresponding filtration membrane.

The improved nanofiltration or reverse osmosis is advantageous if the water comprising an undesirable solute has an osmotic pressure lower than the osmotic pressure of the produced water. The difference in osmotic pressure between the water comprising an undesirable solute and the produced water makes it possible to decrease the osmotic pressure gradient on both sides of the filtration membrane, or even to make it negative. The pressure to be applied on the side of the feeding of the membrane with water comprising an undesirable solute will therefore be lower, thereby making it possible to make energy savings.

The diffusion flow by nanofiltration and by reverse osmosis can typically be calculated according to the following formulae:

Q_{RO}=S_{RO}×L_{P(RO)}×[TMP_{(RO)}+K_{(RO)}×(Π_{P(RO)}−Π_{M})]

and

Q_{NF}=S_{NF}×L_{P(NF)}×[TMP_{(NF)}+K_{(NF)}×(Π_{P(NF)}−Π_{M})]

wherein

Q_{RO} denotes the flow rate of diffusion by reverse osmosis (in l·h⁻¹),

S_{RO} denotes the surface area of the reverse-osmosis membrane (in m²),

L_{P(RO)} denotes the permeability of the osmosis membrane (in l·h⁻¹·m⁻²·bar⁻¹),

TMP_{(RO)} denotes the transmembrane pressure of the osmosis membrane (in bar),

K_{(RO)} denotes the apparent osmosis pressure coefficient, which depends in particular on the salinity of the produced water, and

Π_{P(RO)} and Π_{M} denote the osmotic pressure of, respectively, the produced water and of water having an osmotic pressure lower than the osmotic pressure of the produced water (in bar),

Q_{NF} denotes the flow rate of diffusion by nanofiltration (in l·h⁻¹),

S_{NF} denotes the surface area of the nanofiltration membrane (in m²),

L_{P(NF)} denotes the permeability of the nanofiltration membrane (in l·h⁻¹·m⁻²·bar⁻¹),

TMP_{(NF)} denotes the transmembrane pressure of the nanofiltration membrane, which is the average of the inlet and outlet pressures on the concentrate side minus the average of the inlet and outlet pressures on the produced water side (in bar),

K_{(NF)} denotes the apparent osmotic pressure coefficient, which depends in particular on the salinity of the produced water, and

Π_{P(NF)} and Π_{M} denote the osmotic pressure of, respectively, the produced water and the water having an osmotic pressure lower than the osmotic pressure of the produced water (in bar).

The transmembrane pressure TMP_{(RO)} can preferably be less than 60 bar, more preferably less than 25 bar, and even more preferably between 10 bar and 0 bar.

The transmembrane pressure TMP_{(NF)} can preferably be less than 30 bar, more preferably less than 25 bar, and even more preferably between 15 bar and 0 bar.

The difference in osmotic pressure (Π_{P(NF)}−Π_{M}) in the case of a nanofiltration can generally be between −15 bar and 200 bar. In the case where the flow rate of produced water entering is zero or low, the difference in osmotic pressure (Π_{P(NF)}−Π_{M}) can be between −15 bar and 0 bar. In the case where the flow rate of produced water entering is higher, this difference (Π_{P(NF)}−Π_{M}) can be between 0 bar and 50 bar, or can even go up to 200 bar.

The difference in osmotic pressure (Π_{P(RO)}−Π_{M}) in the case of a reverse osmosis can generally be between Π_{M} (i.e. approximately −25 bar in the case of the use of seawater) and 200 bar. In the case where the flow rate of produced water entering is zero or low, the difference in osmotic pressure (Π_{P(RO)}−Π_{M}) can be between Π_{M} and 0 bar. In the case where the flow rate of produced water entering is higher, this difference (Π_{P(RO)}−Π_{M}) can be between 0 bar and 50 bar, or can even go up to 200 bar.

At the outlet of the filtration unit comprising a nanofiltration or reverse-osmosis membrane, two flows are obtained:
a concentrate originating from the compartment into which the water comprising an undesirable solute enters. Its physicochemical characteristics correspond to those of the flow entering this compartment of the unit, except for a concentration factor. Typically, the concentration of the undesirable solute is higher in the concentrate than in the water comprising an undesirable solute. On the other hand, its flow rate is lower. The concentrate can be expelled from the filtration unit and discharged into the environment in an appropriate manner according to the regulations in force;
a permeate originating from the other compartment of the unit, on the other side of the membrane. The permeate is advantageously devoid of the undesirable solute, and can be used in the process for extracting hydrocarbons as a part of the injection water.

In the process according to the invention, the injection water can consist only of two parts: a first part obtained by direct osmosis and a second part obtained by nanofiltration or by reverse osmosis.

However, also envisioned is the possibility that the injection water used in the process for extracting hydrocarbons according to the invention consists of more than two parts, at least one part obtained by direct osmosis, and at least two other parts chosen from:
a part obtained by conventional nanofiltration,
a part obtained by improved nanofiltration,
a part obtained by conventional reverse osmosis,
a part obtained by improved reverse osmosis.

The various techniques for producing injection water can in fact be combined.

In addition, a part of the injection water can directly be produced water if said produced water is in accordance with the reinjection specifications.

The flow rate of the injection water can therefore be in the form of a sum of the various flow rates of injection water that are obtained simultaneously in various ways:

Qᵢ=Q_{PW}+Q_{DO}+Q_{RO}+Q_{NF}

wherein

Qᵢ denotes the total injection-water flow rate (in l·h⁻¹),

Q_{PW} denotes the reinjected produced-water flow rate (in l·h⁻¹),

Q_{DO} denotes the flow rate of injection water obtained by direct osmosis (in l·h⁻¹),

Q_{RO} denotes the flow rate of injection water obtained by reverse osmosis (in l·h⁻¹),

Q_{NF} denotes the flow rate of injection water obtained by nanofiltration (in l·h⁻¹).

The combined use of several techniques for producing injection water makes it possible to meet the need of adaptation to the conditions for exploiting the hydrocarbon reservoir. Depending on the produced-water flow rates available, the techniques which make it possible to produce injection water in a sufficient amount at the lowest possible energy cost are not the same.

Thus, a subject of the present invention consists of a process for extracting hydrocarbons using injection water, wherein the method for producing injection water varies according to the stage of exploitation of the hydrocarbon reservoir. In this process for extracting hydrocarbons, the process described above is implemented in at least one exploitation stage.

The process for extracting hydrocarbons may comprise at least three exploitation stages.

Generally, in the first stage of exploitation of a hydrocarbon reservoir, the amount of produced water produced is low. It is therefore advantageous to produce the required injection water by processes of nanofiltration and/or reverse osmosis of water comprising an undesirable solute. Nanofiltration may be favored insofar as it generally requires a weaker osmotic pressure gradient than that of reverse osmosis. If produced water is available, it may then be advantageous to at least partly produce injection water by improved nanofiltration.

After this initial exploitation phase, the amount of produced water produced gradually increases. During a second exploitation stage, at least one part of the injection water is a permeate obtained by nanofiltration and/or reverse osmosis of water comprising an undesirable solute, and at least one other part of the injection water is a permeate obtained by bringing into contact, in a direct-osmosis unit, on both sides of an osmosis membrane, at least one part of produced water and water having an osmotic pressure lower than the pressure of the produced water and comprising an undesirable solute. During this second stage, the process involved may be the process which is the subject of the present invention described above. This second exploitation stage can be implemented as described above in detail. In particular, depending on the amount of produced water available, it is possible to couple a production of injection water by direct osmosis with a production of injection water by improved nanofiltration or by improved reverse osmosis. According to this preferred embodiment, during a second exploitation stage, at least one part of the injection water is a permeate obtained by improved nanofiltration and/or improved reverse osmosis of water comprising an undesirable solute, the water comprising an undesirable solute being brought into contact, via respectively a nanofiltration and/or reverse-osmosis membrane, with produced water.

Finally, when the flow rate of produced water is sufficient, it is possible for the injection water to be produced only by direct osmosis, thereby representing a considerable energy gain. Thus, during a third exploitation step, the injection water is a permeate obtained by bringing into contact, in a direct-osmosis unit, on both sides of an osmosis membrane, produced water and water having an osmotic pressure lower than the pressure of the produced water and comprising an undesirable solute.

Those skilled in the art will be able to add other preliminary, inserted or subsequent stages to these various stages of hydrocarbon production.

The process for extracting hydrocarbons according to the invention advantageously makes it possible to produce the injection water required for the extraction of hydrocarbons in a sufficient amount, at a minimum energy cost, throughout the exploitation of the underground hydrocarbon reservoir. This process does not require the use of a synthetic solution: the injection water is obtained from readily available water, in particular seawater in the case of an offshore process. In addition, this process makes it possible to take advantage of the produced water which is often considered to be waste, the management of which is problematic.

Furthermore, the process for extracting hydrocarbons according to the invention is simple to implement throughout the exploitation of the hydrocarbon reservoir and it can be implemented by virtue of an inexpensive device. Indeed, the inventors have discovered that the injection water produced by various processes as described in the process according to the invention can nevertheless be produced in a single simple and adjustable device, which can be used optimally throughout the exploitation of the hydrocarbon reservoir.

A subject of the present invention is therefore also an injection-water production device, that can be used in the processes for extracting hydrocarbons described above, comprising several filtration units, each unit comprising at least one filtration membrane chosen from membranes of nanofiltration type, of reverse-osmosis type and of direct-osmosis type, the filtration membrane of each unit being removable and can be replaced with a filtration membrane of another type.

The configuration of these membranes is preferably a spiral configuration which advantageously makes it possible to work under pressure at the beginning of the field lifetime. In the case where a direct osmosis can be carried out right at the beginning of the field lifetime (by supplying produced water from neighboring fields for example), other membrane configurations can be envisioned, such as hollow-fiber or flat modules. These modules can be installed on an offshore platform or immersed in water of lower salinity containing a compound to be removed (seawater for example).

The injection-water production device especially designed for implementing the process according to the invention comprises at least two filtration units. Each unit conventionally comprises a casing and at least one filtration membrane.

The casing, i.e. the rigid shell which surrounds the membrane(s) regardless of the configuration thereof, can be equipped with two inlets on either side of the membrane and two outlets also on either side of the membrane. The presence of two inlets allows the unit to operate either in nanofiltration mode, or in improved nanofiltration mode, or in reverse osmosis mode, or in improved reverse osmosis mode, or in direct osmosis mode. The casing is preferably provided to withstand at least a pressure of 30 bar, preferentially of 40 bar, and more preferentially of 50 bar.

Each filtration unit can comprise a single membrane, or else several membranes, which are preferably identical, arranged in parallel. The nature of the membrane is chosen according to the filtration process that it is desired to implement in the filtration unit. The membrane can in particular be chosen from membranes of nanofiltration type, of reverse-osmosis type and of direct-osmosis type.

The term “membrane of nanofiltration type” is intended to mean any membrane which makes it possible to retain organic molecules and inorganic molecules of very low molecular weight, in particular sulfates. A nanofiltration membrane is often characterized by its capacity to retain multivalent ions and to allow a part of the monovalent ions to pass through. The nanofiltration membranes may be polymeric, ceramic, made of aligned carbon nanotubes, made of aquaporin, made of a mixed polymer-nanoparticle matrix, or a combination of these various options. They may be in flat, spiral, tubular or hollow-fiber form. Nanofiltration membranes are currently commercially available and may be suitable for the present application. Mention may be made, for example, of the membranes from Dow or from Hydranautics.

The terms “membrane of direct-osmosis type” and “membrane of reverse-osmosis type” are intended to mean any semipermeable membrane that allows only the solvent (generally water) to pass through, and not the other substances in solution, in particular multivalent and monovalent salts. The direct-osmosis and reverse-osmosis membrane may be an organic membrane consisting of polymer or copolymer materials, for instance cellulose acetate, cellulose nitrate, polysulfone, polyvinylidene fluoride, polyamide and acrylonitrile. The osmosis membrane may also be a mineral or ceramic membrane consisting of materials such as silicon carbide, alumina, zeolite, zirconia, titanium oxide or mixed silica and alumina or silica and zirconia oxides. The osmosis membrane may also be a mixed nanoparticle-polymer membrane, a membrane based on aligned or dispersed carbon nanotubes, or a membrane containing aquaporins, such as those described in patent application WO 2006/122566. It may be in flat, spiral, tubular or hollow-fiber form. Many membranes intended for reverse-osmosis applications are currently commercially available and may be suitable for the present application. Mention may, for example, be made of the Qfx membranes from NanoH2O, and the commercial reverse-osmosis membranes from, for example, Dow, Hydranautics, Osmonics and Toray. The osmosis membrane according to the invention can be produced according to various configurations known to those skilled in the art. For example, the osmosis membrane may be arranged in the form of a spiral, of hollow fibers or of a sheet. The choice of the nature and of the configuration of the membrane can depend on the volume of the flows treated, on the compactness, on the quality of the membrane contact feeds and on the robustness desired.

Each filtration unit is designed to allow the circulation of a solution with a high osmotic pressure on one side of the membrane and of a solution with a low osmotic pressure on the other side of the membrane. Any configuration of the filtration unit which makes it possible to bring two waters of different salinity into contact can be used for this application. Mention may in particular be made of the spiral models as developed for conventional direct-osmosis units, hollow-fiber modules equipped with direct-osmosis and/or nanofiltration membranes in internal/external or external/internal filtration and modules in flat configuration, for instance for plate filtration or plate-and-frame filtration.

In the device according to the invention, the filtration units are arranged in parallel. The inlet and the outlet of the flows in each unit can be managed using valves. At a given time, several units can be operating to produce injection water. By virtue of the arrangement of the units in parallel, it is possible to momentarily stop one or more units without completely stopping the production of injection water required for the exploitation. It may be required to stop a unit in order to clean or change a filtration membrane.

In the device according to the invention, the filtration membrane of each unit is removable and can be replaced with a filtration membrane of another type. Each filtration unit is therefore designed so as to accept without distinction a membrane of direct-osmosis type, of reverse-osmosis type or of nanofiltration type. Thus, according to the type of membrane placed in the unit, the unit can implement different processes, and these processes can change over time, simply and inexpensively, by replacing the membrane.

However, it is not out of the question for the device according to the invention to additionally comprise one or more non-adjustable fixed filtration units operating as a supplement to the adjustable units described herein. These units can couple various flat, hollow-fiber and spiral filtration configurations.

According to one embodiment, the device according to the invention can initially comprise several nanofiltration units making it possible, at the initial stage of the hydrocarbon field lifetime, to produce the required amount of injection water, without the help of produced water. The produced water produced can then be injected on the permeate side of the nanofiltration membranes in order to perform an improved nanofiltration. When the flow rate of produced water becomes sufficiently high to generate by osmosis the required flow of injection water, the nanofiltration membranes are gradually replaced with the direct-osmosis membranes. The process for extracting hydrocarbons using the device according to the invention may comprise, between each exploitation stage, steps consisting in replacing the membranes in the filtration units.

The filtration units may conventionally pose clogging problems. In particular, since the osmosis and nanofiltration membranes stop most of the matter dissolved or in suspension in the diffusing flow, except the solvent which in this case is water, there may be an accumulation, at the surface of the membrane, of particles, of microorganisms, of organic compounds and/or of salts. This accumulation can cause degradations at the level of the filtration unit, which can cause a decrease in yield, or even irreversible clogging of the membrane. In addition, conventional spiral osmosis and nanofiltration units comprise grids (commonly referred to as “spacers”) which can themselves also become fouled and greatly limit the performance levels of the process. Thus, correct operating of the filtration units generally depends on the quality of the flows which are introduced therein.

The process according to the invention may also comprise a step consisting in pretreating the produced water and/or the water having an osmotic pressure lower than the pressure of the produced water and/or the water comprising an undesirable solute before introduction into the direct-osmosis unit or before nanofiltration and/or reverse osmosis. The injection-water production device according to the invention may therefore also comprise one or more pretreatment units which make it possible to pretreat one or more of the flows entering the filtration units.

More specifically, the process may comprise a step consisting in pretreating the produced water in a first pretreatment unit before introducing it into the direct-osmosis unit. In addition or alternatively, the process according to the invention may comprise a step consisting in pretreating the water having an osmotic pressure lower than the osmotic pressure of the produced water in a second pretreatment unit before introducing it into the direct-osmosis unit. In addition or alternatively, the process according to the invention may comprise a step consisting in pretreating the water comprising an undesirable solute in a third pretreatment unit before nanofiltration thereof and/or reverse osmosis thereof. The process may therefore comprise either a step of pretreating the produced water, or a step of pretreating the water having an osmotic pressure lower than the osmotic pressure of the produced water, or a step of pretreating the water comprising an undesirable solute, or two of these steps, or all three. When the three steps are present, they may be identical or different. If the water having an osmotic pressure lower than the osmotic pressure of the produced water and the water comprising an undesirable solute are the same water, for example seawater, the second and third pretreatment units may be a single unit. Advantageously, when the injection-water production device comprises several pretreatment units and said pretreatment units are identical. This embodiment thus makes it possible to make the units interchangeable, which, from an industrial point of view, makes the process simple to set up, to operate and to maintain.

The pretreatment step(s) may consist, independently of one another, of a filtration step or of a series of several successive filtration steps, it being possible for the filtrations to be identical or different. Advantageously, the pretreatment step(s) comprise(s) at least one ultrafiltration step. The ultrafiltration, which is a technique known to those skilled in the art, is typically carried out using an ultrafiltration membrane. In the present invention, an “ultrafiltration membrane” denotes a membrane comprising pores of which the diameter is between 1 nm and 100 nm. Mention may be made, for example, of the commercial polymer ultrafiltration membranes from the companies Polymem, Zenon, Kubota and Pall, and the ceramic ultrafiltration membranes from the companies Pall, Ceramem, Cometas and Inopore.

The pretreatment step(s) may also comprise at least one deep filtration step.

The pretreatment step(s) may also comprise at least one step of removing chlorine and also dissolved oxygen.

The pretreatment advantageously makes it possible to increase the lifetime of the membranes by removing the particles, the microorganisms and/or the hydrocarbons in dispersion in the produced water, thus limiting the fouling of the unit and the clogging of the membranes.

The choice of the pretreatment steps and of the pretreatment units to be used depends essentially on the composition of the flows entering the units and on the specification to be achieved so that the pretreated flow does not damage the filtration units.

Advantageously, the pretreated flows contain neither particles nor microorganisms. In addition, the pretreated flows can have an active chlorine concentration of advantageously less than 0.1 mg/l. Furthermore, the pretreated flows can have a concentration of hydrocarbons in dispersed form of advantageously less than 5 mg/l. The implementation of a pretreatment of the produced water advantageously makes it possible to remove the hydrocarbons in dispersion, the microorganisms and the particles, and thus to achieve the specifications required for the injection water.

The process which is the subject of the invention can optionally comprise a step of post-treatment of the permeates obtained at the outlet of the filtration units, before said permeates are introduced into the underground formation. The post-treatment can, for example, consist of a deoxygenation. Deoxygenation of injection water is commonly used to prevent the development of bacteria in oil wells.

Other characteristics and advantages of the invention will emerge from the embodiment and the example described below.

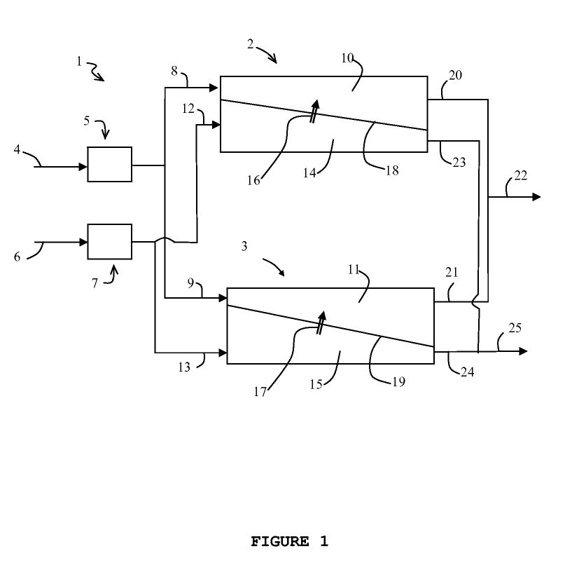

Represented in FIG. 1 is an embodiment of the process for producing injection water according to the invention.

The injection-water production device 1 comprises two filtration units 2 and 3. The produced water 4 is pretreated by means of the pretreatment unit 5. The water having a lower osmotic pressure and which contains an undesirable solute 6, typically seawater, is pretreated by means of the pretreatment unit 7.

Said pretreatment unit 5 comprises the pretreatments required to obtain water which observes the reinjection specifications. The flow of produced water 4 is preferably prefiltered on prefilters having a diameter ranging from 500 nm to 10 nm, then filtered on an ultrafiltration membrane.

Said pretreatment unit 7 preferably comprises at least one ultrafiltration device or one deep filter. Preferably, the first pretreatment unit 5 and the second pretreatment unit 7 are identical.

Two pretreated produced-water flows 8 and 9 are obtained at the outlet of the first pretreatment unit 5 and are introduced into the chambers 10 and 11 of the units 2 and 3. Pretreated flows 12 and 13 are obtained at the outlet of the second pretreatment unit 7 and are introduced into the second chambers 14 and 15 of the units 2 and 3.

Regardless of the membranes 18 and 19 used, a flow of water free of any undesirable solute 16 and 17 diffuses through the membranes 18 and 19 from the second chamber 14 and 15 to the first chambers 10 and 11. The set of permeates 20 and 21 are then combined before being used as injection water 22. Two concentrates 23 and 24 are recovered at the outlet of the second chambers 14 and 15. These concentrates can be combined into one flow 25 and discharged from the device in an appropriate manner.

At the beginning of the oil field production, the filtration units 2 and 3 can be equipped with nanofiltration membranes 18 and 19 making it possible to retain said compound to be removed, typically the sulfate ions, in the flows 12 and 13. At this initial stage of production, the flow rate of produced water is too low, and no flow 4 enters the device 1. A pump (not represented) makes it possible to supply the pressure required to obtain two permeate flows 16 and 17 through the nanofiltration membranes 18 and 19. In the case of desulfation by nanofiltration, known to those skilled in the art, the operating pressure is conventionally between 30 and 40 bar.

When the flow of produced water 4 increases, the flows 8 and 9 can be introduced into the chambers 10 and 11 of the nanofiltration units 2 and 3. The difference in osmotic pressure between the flows 8 and 12 and also 9 and 13 decreases, which makes it possible to decrease the operating pressure.

When the osmotic pressure of the chambers 10 and 11 reaches an osmotic pressure equal to that of the chambers 14 and 15, the process is then no longer limited by the osmotic pressure.

When the osmotic pressure of the compartment 10 exceeds that of the compartment 14 in the nanofiltration unit 2, the flow of permeate 16 can be broken down into two flows: an osmosis flow which is dependent on the osmotic pressure gradient and a permeate flow produced by means of the mechanical pressure gradient. The nanofiltration membrane 18 can then be replaced with a direct-osmosis membrane, with a greater retention, but also less concentration polarization impact. The flow of injection water 22 is then obtained partially by direct osmosis in the unit 2 and partially by improved nanofiltration in the unit 3.

Next, when the amount of produced water is sufficient, the nanofiltration membrane 19 can also be replaced in the unit 3 with a direct-osmosis membrane. It is thus possible to decrease the pressure required for the operation of the device to reach that of solely the pressure drops of the direct-osmosis units, i.e. generally a maximum of 3 to 6 bar.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. A process for extracting hydrocarbons comprising the steps of:
i. extracting a production flow from an underground formation;
ii. separating this flow into at least one hydrocarbon-containing fraction and one aqueous fraction referred to as the produced water, and
iii. reintroducing an injection Water into the underground formation,
wherein:
at least a first part of said injection water is a permeate obtained by bringing into contact, in a direct-osmosis unit, on both sides of an osmosis membrane, at least one part of the produced water and a water having an osmotic pressure lower than the pressure of the produced water and comprising an undesirable solute, and
at least a second part of said injection water is a permeate obtained by nanofiltration and/or reverse osmosis of water comprising an undesirable solute.

2. The process as claimed in claim 1, wherein, said water having an osmotic pressure lower than the osmotic pressure of the produced water and said water comprising an undesirable solute are seawater.

3. The process as claimed in claim 1, wherein the undesirable solute is the sulfite ion.

4. The process as claimed in claim 1, wherein said second part of injection water is a permeate obtained by improved nanofiltration and/or improved reverse osmosis of water comprising an undesirable solute, the water comprising an undesirable solute being brought into contact, via respectively a nanofiltration and/or reverse-osmosis membrane, with produced water.

5. The process as claimed in claim 1, wherein it also comprises a step consisting in pretreating the produced water and/or the water having an osmotic pressure lower than the pressure of the produced water and/or the water comprising an undesirable solute before introduction into the direct-osmosis unit or before nanofiltration and/or reverse osmosis.

6. A process for extracting hydrocarbons using injection water, wherein,
during a first exploitation stage, the injection water is a permeate obtained by nanofiltration and/or reverse osmosis of water comprising an undesirable solute;
during a second exploitation stage, at least one part of the injection water is a permeate obtained by nanofiltration and/or reverse osmosis of water comprising an undesirable solute, and at least one other part of the injection water is a permeate obtained by bringing into contact, in a direct-osmosis unit, on both sides of an osmosis membrane, at least one part of produced water and a water having an osmotic pressure lower than the pressure of the produced water and comprising an undesirable solute; and
during a third exploitation stage, the injection water is a permeate obtained by bringing into contact, in a direct-osmosis unit, on both sides of an osmosis membrane, produced water and a water having an osmotic pressure lower than the pressure of the produced water and comprising an undesirable solute.

7. The process as claimed in claim 6, wherein,
during a second exploitation stage, at least one part of the injection water is a permeate obtained by improved nanofiltration and/or improved reverse osmosis of water comprising an undesirable solute, the water composing an undesirable solute being brought into contact, via respectively a nanofiltration and/or reverse-osmosis membrane, with produced water.

8. An injection-water production device that can be used in the processes for extracting hydrocarbons as claimed in claim 1, comprising several filtration units, each unit comprising at least one filtration membrane chosen from membranes of nanofiltration type, of reverse-osmosis type and of direct-osmosis type, the filtration membrane of each unit being removable and can be replaced with a filtration membrane of another type.

9. The device as claimed in claim 8, wherein it also comprises one or more pretreatment units which make it possible to pretreat one or more of the flows entering the filtration units.

10. The device as claimed in claim 9, wherein the device comprises several pretreatment units and said pretreatment units are identical.

11. An injection-water production device that can be used in the processes for extracting hydrocarbons as claimed in claim 6, comprising several filtration units, each unit comprising at least one filtration membrane chosen from membranes of nanofiltration type, of reverse-osmosis type and of direct-osmosis type, the filtration membrane of each unit being removable and can be replaced with a filtration membrane of another type.

12. An injection-water production device that can be used in the processes for extracting hydrocarbons as claimed in claim 11 comprising several filtration units, each unit comprising at least one filtration membrane chosen from membranes of nanofiltration type, of reverse-osmosis type and of direct-osmosis type, the filtration membrane of each unit being removable and can be replaced with to filtration membrane of another type.

13. An injection-water production device that can be used in the processes for extracting hydrocarbons as claimed in claim 12, comprising several filtration units, each unit comprising at least one filtration membrane chosen from membranes of nanofiltration type, of reverse-osmosis type and of direct-osmosis type, the filtration membrane of each unit being removable and can be replaced with a filtration membrane of another type.
